(19) United States
(12) Patent Application Publication
(10) Pub. No.: US 2006/0180204 A1
(43) Pub. Date: Aug. 17, 2006

(54) Metering unit for soil or plant improvement agents

(76) Inventors: Hans-Joachim Prutzer, Nauheim (DE); Manfred Simoneit, Calw-Stammheim (DE); Peter Shaw, Neufahrn (DE)

Correspondence Address: WILLIAM COLLARD;COLLARD & ROE, P.C., 1077 NORTHERN BOULEVARD, ROSLYN, NY, 11576, US

(21) Appl. No.: 11/070,384

(22) Filed: Mar. 2, 2005

(30) Foreign Application Priority Data
Feb. 15, 2005 (DE) 20 2005 002 496.1

(51) Int. Cl. G05D 7/00

(52) U.S. Cl. 137/268

(57) ABSTRACT

A metering unit for soil and plant improvement agents to increase the water absorption capacity of the soil, comprises a first inlet connector that can be connected with a watering line, a second outlet connector that can be connected with a watering line, a flow channel that runs between the inlet connector and the outlet connector, a bypass channel that branches off from the flow channel in a flow direction, leads into a mixing chamber for admixing a soil or plant improvement agent, and opens into the flow channel again from the mixing chamber, and a metering valve disposed in the flow channel, the metering valve regulating both flow-through amount through the flow channel and flow-through amount through the bypass channel at the same time.

### BACKGROUND OF THE INVENTION

1. Field of the Invention

The invention relates to a metering unit for soil or plant improvement agents, particularly for wetting agents to increase the water absorption capacity of the soil. The metering unit has a first inlet connector that can be connected with a watering line, a second outlet connector that can be connected with a watering line, a flow channel that runs between the inlet connector and the outlet connector, and a bypass channel that branches off from the flow channel in the flow direction, leads into a mixing chamber for admixing a soil or plant improvement agent, and opens into the flow channel again from this chamber.

2. The Prior Art

Sports fields and golf courses, park grounds or the like are frequently artificially watered in order to improve lawn growth. Particularly after a major drought, the water absorption capacity is not sufficient to rapidly absorb the amount of water distributed by a watering or sprinkling system. It is therefore known to apply a wetting agent to the soil before or during sprinkling, by means of which the surface tension of the soil is reduced and as a result of which its water absorption capacity is improved. Individual application of a wetting agent, using a watering can or the like, however, is very time-intensive, particularly in the case of large sports fields or golf courses and park grounds.

An intermediate piece for mixing the water for sprinkler systems with fertilizer, which piece is placed in a pressurized water line, is described in German Patent No. DE 248 486. The intermediate piece has a flow channel and a bypass channel switched in parallel to the former, which bypass channel is passed through a container in which an insertion sieve for the fertilizer is provided, so that the fertilizer is gradually placed in solution as the water is passed through the container. In order to control the amount of fertilizer that is admixed into the sprinkling water, shut-off valves are disposed at the inlet and the outlet of the bypass channel, in each instance. To meter the amount of fertilizer to be admixed to the water, four different valves therefore have to be activated manually, which is complicated.

An improvement system having a watering feed line containing a filter is described in European Patent No. EP 0 753 254 B1. Filter elements are disposed in the filter, which are formed of a material impregnated with herbicide. In this connection, the filter is disposed in a bypass channel that branches off from the main water line. Several solenoids, which can be centrally controlled, for example, are provided both in the main water line and in the bypass channel, in order to be able to control the flow-through amount through the main water line and the amount of the herbicide that is metered in. This requires a great amount of effort for control. In addition, the failure of a single valve can disrupt the function of the entire metering unit, so that this known watering system is comparatively susceptible to breakdown.

### SUMMARY OF THE INVENTION

In contrast, it is an object of the present invention to create a metering unit of the type stated initially, and a watering system, which makes possible a precise admixture of a soil or plant improvement agent and, at the same time, is easy to operate and not subject to breakdowns.

This object is accomplished, according to the invention, by providing a metering valve in the flow channel, by means of which both the flow-through amount through the flow channel and the flow-through amount through the bypass channel can be regulated at the same time. For a defined admixture of a wetting agent to increase the water absorption capacity of the soil, for example, only one valve has to be provided, thereby not only improving the ease of operation and the effort for regulation, but also making it possible to lower the production costs as compared with known systems having several valves.

According to a preferred embodiment of the invention, the metering valve has a first closure disk, which is adapted to the inside contour of the flow channel in such a manner that the first closure disk can be moved from a closed position in which it at least essentially blocks a flow-through channel, into an open position in which it at least does not significantly hinder a flow through the flow channel, or vice versa, by means of a rotation by 90°. In a further embodiment of the invention, the flow channel is separated from the mixing chamber by a wall in which two openings are provided, which form the two ends of the bypass channel. In this connection, the metering valve preferably has a second closure disk, by means of which at least one of the two openings can be opened and closed. By means of this configuration of the metering valve, it is possible to regulate both the flow-through amount through the flow channel and the flow-through amount through the bypass channel, using only a single metering valve.

If the first and the second closure disk are coupled with one another in such a manner that the second closure disk, in the open position of the first closure disk, at least essentially blocks a flow through the bypass channel and, in the closed position of the first closure disk, at least does not significantly hinder a flow through the bypass channel, the flow-through amount through the flow channel can be reduced, and the flow-through amount through the bypass channel can be increased, in order to increase the amount of the soil or plant improvement agent admixed to the water. Vice versa, in order to reduce the amount of the wetting agent or the like that is admixed to the water, the bypass channel can also be completely or partially closed, so that the water essentially flows only through the flow channel.

The structure of the metering unit according to the invention can be kept particularly compact because the mixing chamber is formed by a housing, particularly a cylindrical housing, in which a riser pipe that is disposed centrally, for example, is provided, which can be connected with the flow channel, and which defines a ring-shaped region of the mixing chamber, together with the housing. The water branched out of the flow channel therefore first flows through the riser pipe and then through the ring-shaped region of the mixing chamber, in which a tablet of a wetting agent or the like, also configured in ring shape, for example, is accommodated. In this way, the wetting agent is gradually dissolved and passed back into the flow channel together with the water that flows through the bypass channel.

The handling of the metering unit according to the invention can be further improved if an activation element is assigned to the metering valve, which element has a drive rod that extends through the riser pipe. For manual activation, the metering valve can be connected with a handle to which a display device and/or a scaling is/are assigned, for example. The metering amount set can thereby be read off at a glance, and can be changed by means of a rotation of the handle, if necessary. Alternatively or in addition to this, it is also possible to provide a motor, a setting element or the like for motor activation of the metering valve. In this way, the metering unit according to the invention can also be controlled by means of a central computer unit.

Preferably a grate, for example a ring-shaped grate, is provided in the mixing chamber, onto which tablets, particularly ring-shaped tablets of a wetting agent or the like can be set in such a manner that the fluid, such as water, that flows through the bypass channel washes around them and slowly dissolves them. The greenskeeper of a golf course therefore merely has to refill the metering unit with ring-shaped tablets of the soil or plant improvement agents, which tablets are particularly adapted to the shape of the mixing chamber. The wetting agent can then be applied to the greens at the same time with the sprinkling water, by means of one or more sprinklers.

Alternatively to this, a line may branch off from the bypass channel, which line is connected with a container for a soil or plant improvement agent that is capable of flow, in such a manner that the soil or plant improvement agent capable of flow is introduced into the bypass channel by means of the fluid pressure in the line, by way of a feed line. This can take place with particularly simple means, in that a piston is displaceably disposed in the container, which piston divides the container into a first chamber in which the line ends, and a second chamber from which the feed line branches off. In this connection, the piston can have a larger effective piston surface on the side that faces the first chamber than on the side that faces the second chamber. Since furthermore, the fluid pressure in the line is at least slightly higher than in the feed line, the second chamber, in which the liquid wetting agent or the like is accommodated, is gradually emptied by means of a slow displacement of the piston, so that the wetting agent is admixed to the water that flows through the bypass channel, in the mixing chamber. To fill the container, the piston merely has to be pushed back, so that the first chamber is emptied.

Emptying or venting of the mixing chamber can be facilitated in that a drain valve is provided in the vertically lower region of the mixing chamber, and/or a ventilation valve is provided in the vertically upper region of the mixing chamber.

If the housing of the mixing chamber is closed off by a cover that can be releasably attached to the housing by a screw connection, it is possible, in a particularly simple manner, to fill the mixing chamber with ring-shaped tablets, for example.

The task underlying the invention is furthermore accomplished by means of a watering system having a water line and at least one sprinkler or the like connected with it, which is preceded by a valve, particularly a centrally controllable valve. A metering unit of the type stated initially is disposed in the water line behind the valve, in the flow direction. The valve can be a centrally controlled solenoid, in the case of block control of the watering system, which solenoid is disposed in the main water line. By placing the metering unit behind the valve, ventilation of the metering unit is possible. In the pressure-free state, the metering unit consequently runs empty, so that a wetting agent tablet accommodated in it, for example, will only dissolve if water is actually flowing through the metering unit. Clumping of the wetting agent can also be prevented in this manner.

For individual control of the sprinklers, i.e. if a separate solenoid is assigned to each sprinkler, a shut-off slide is provided, in most cases, in each branch line branching off from a main water line, by means of which slide the branch line can be cut off from the main water line. In this case, the metering unit is preferably disposed, in the flow direction, behind at least one of the shut-off slides.

In the case of a large area to be sprinkled, only certain regions of which are supposed to be sprinkled with a wetting agent or the like, it has proven to be advantageous to dispose the metering unit not in the main water line but rather in one or more of the branch lines. So that a metering unit does not have to be provided in each of the branch lines, the metering unit can also be configured in such a manner that it can easily be integrated into a water line and removed from it again.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a cross-section through a metering unit according to a first embodiment of the invention,

FIG. 2 shows the metering unit according to FIG. 1 in a different metering position,

FIG. 3 shows a top view of the metering unit according to FIG. 1,

FIGS. 4a-c show different opening positions of the metering valve of the metering unit according to FIG. 1,

FIG. 5 shows the metering unit according to FIG. 1, integrated into a watering system,

FIG. 6 shows a cross-section of a metering unit according to a second embodiment of the invention,

FIG. 7 shows a wetting agent container for the metering unit according to FIG. 6, and

FIG. 8 shows the metering unit according to FIG. 6, integrated into a watering system.

### DETAILED DESCRIPTION OF THE PREFERRED EMBODIMENT

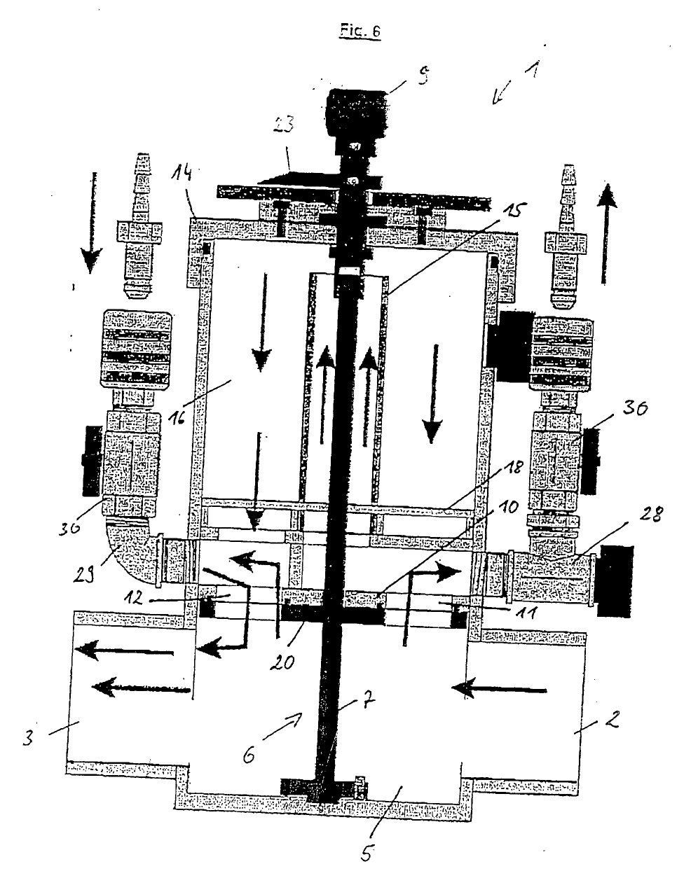

Referring now in detail to the drawings, the metering unit according to the first embodiment shown in FIGS. 1 to 5 has an inlet connector 2 and an outlet connector 3, with which metering unit 1 can be integrated into a water line 4, as shown in FIG. 5. A flow channel 5, in which a metering valve 6 is disposed, runs through metering unit 1 between inlet connector 2 and outlet connector 3.

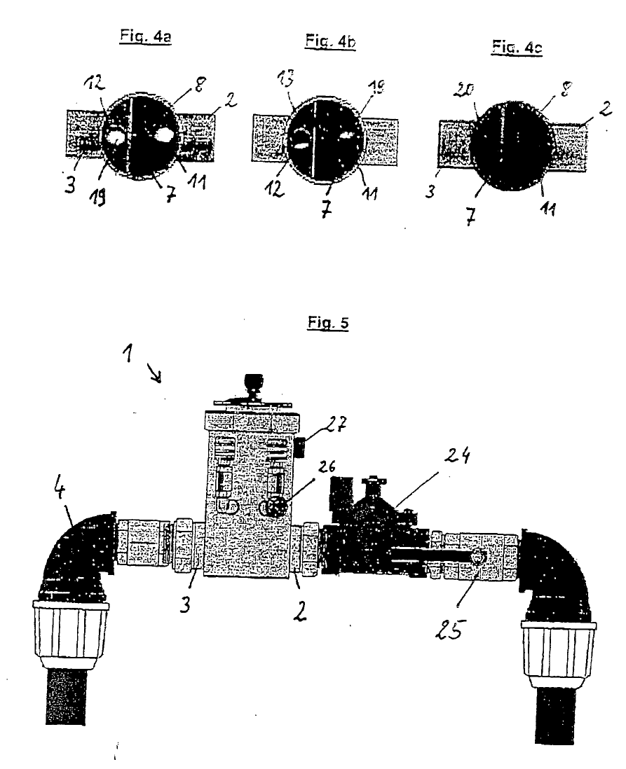

Metering valve 6 is equipped with a first closure disk 7, which can be pivoted between an open position shown in FIG. 1, in which the flow through flow channel 5 is at least essentially not hindered, and a closed position shown in FIG. 2, in which the first closure disk 7 at least essentially blocks a flow through flow channel 5, by way of a drive rod 8 and a handle 9. The various positions of first closure disk 7 of metering valve 6 can also be seen in FIGS. 4a to 4c. In this connection, FIG. 4a shows a closed position corresponding to the representations in FIG. 2, while FIG. 4c shows the open position according to FIG. 1, in which flow through flow channel 5 is made possible.

Flow channel 5 is closed off, towards the top, with a plate 10 in which two openings 11 and 12, respectively, are disposed in such a manner that first opening 11 lies on the side of inlet connector 2, relative to first closure disk 7 of the metering valve, while second opening 12 lies on the side of outlet connector 3. The two openings 11 and 12 in wall 10 define the two ends of a bypass channel. This bypass channel extends through a cylindrical housing 13 disposed on flow channel 5, which housing is closed off with a screw-on lid 14. A central riser pipe 15 is disposed in housing 13, which pipe is connected with first opening 11, allowing flow. Riser pipe 15 is structured to be open on its side facing the lid 14, so that water can flow out of first opening 11 through the riser pipe 15, into a ring-shaped region 16, which is defined by the inside wall of the housing 13 and the outside wall of the riser pipe 15.

This ring-shaped region forms a mixing chamber 16, in which several ring-shaped tablets 17 of a wetting agent are accommodated, in the embodiment shown. On the side of mixing chamber 16 that faces flow channel 5, a grate 18 is provided, on which ring-shaped tablets 17 are held. Furthermore, mixing chamber 16 is connected with second opening 12 by way of grate 18, so that water from mixing chamber 16, with which the water containing the wetting agents of tablets 17 mixes, is passed back into flow channel by means of second opening 12.

Metering valve 6 furthermore has a second closure disk 20 provided with two openings 19, which disk lies against wall 10, essentially forming a seal. Openings 19 in second closure disk 20 are disposed so that they release the two openings 11 and 12 in the wall in the closed position of first closure disk 7, while second closure disk 20 closes off the two openings 11 and 12 in the wall 10 in the open position of first closure disk 7. In this connection, second closure disk 20 is coupled with drive rod 8 in such a manner that the first and second closure wall can be activated jointly.

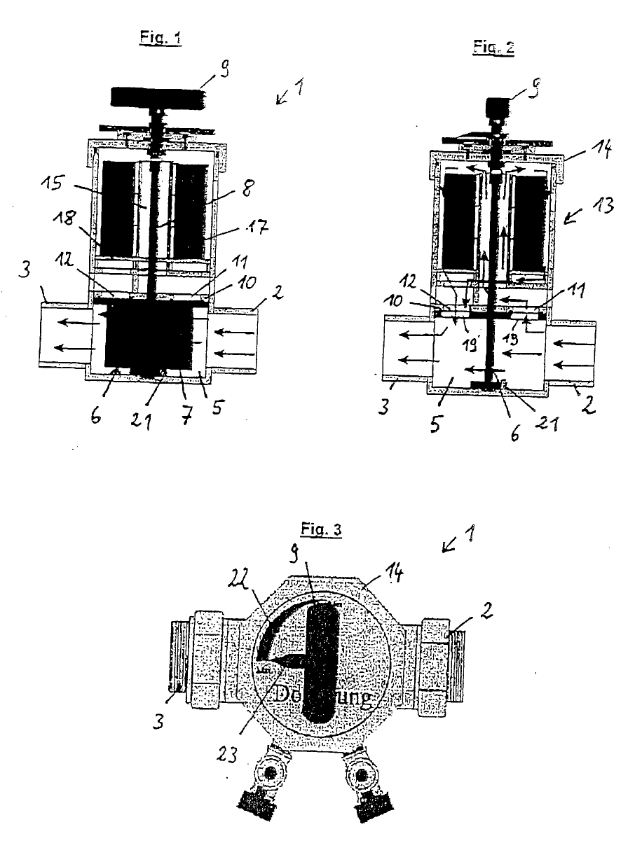

At the bottom of flow channel 5, stops 21 can be provided, so that metering valve 6 can be set between two defined end positions, in which the water is passed either through the flow channel 5 or through the bypass channel. Furthermore, a scaling 22 can be applied to lid 14 of housing 13, as shown in FIG. 3, in order to be able to read and adjust the setting of the metering valve, using a display device 23 that is provided on handle 9.

Metering unit 1 is positioned in water line 4, as shown in FIG. 5, so that the metering unit is disposed downstream of a centrally controllable solenoid 24 or a shut-off slide 25, respectively. A drain valve 26 can be provided on housing 13, in the lower region of mixing chamber 16, and a ventilation valve 27 can be provided in the upper region of the mixing chamber 16, so that in the pressure-free state, i.e. after solenoid 24 or shut-off valve 25, respectively, has been shut off, mixing chamber 16 can run empty, in order to prevent clumping of ring-shaped tablets 17 of the wetting agent.

In the case of the second embodiment of the invention shown in FIGS. 6 to 8, the structure of metering unit 1 essentially corresponds to that of the metering unit described above. In order to admix a soil or plant improvement agent that is capable of flow to the water, in addition to or alternatively to the wetting agent that is present in tablet form, two branching connection pieces 28 and 29, respectively, are provided between grate 18 and the wall 10, whereby the first branching connection piece 28 forms a flow connection with first opening 11 in wall 10, and the second branching connection piece 29 forms a flow connection with second opening 12 in wall 10. A shut-off cock 30 can be assigned to branching connection pieces 28 and 29.

As is evident from the representation of FIG. 8, the first branching connection piece 28 is connected with a line 31, which opens into a container 32. Container 32 is furthermore connected with second branching connection piece 29 by way of a feed line 33.

A piston 34 is displaceably disposed in container 32, which piston divides the container into a first chamber 35, into which the line 31 opens, and a second chamber 36, from which the feed line 33 branches off. Piston 34 has a piston rod 37 with a handle assigned to it, so that the piston surface on the side of first chamber 35 is larger than that on the side of second chamber 36. Furthermore, the flow pressure in line 31 is slightly higher than the flow pressure in feed line 33.

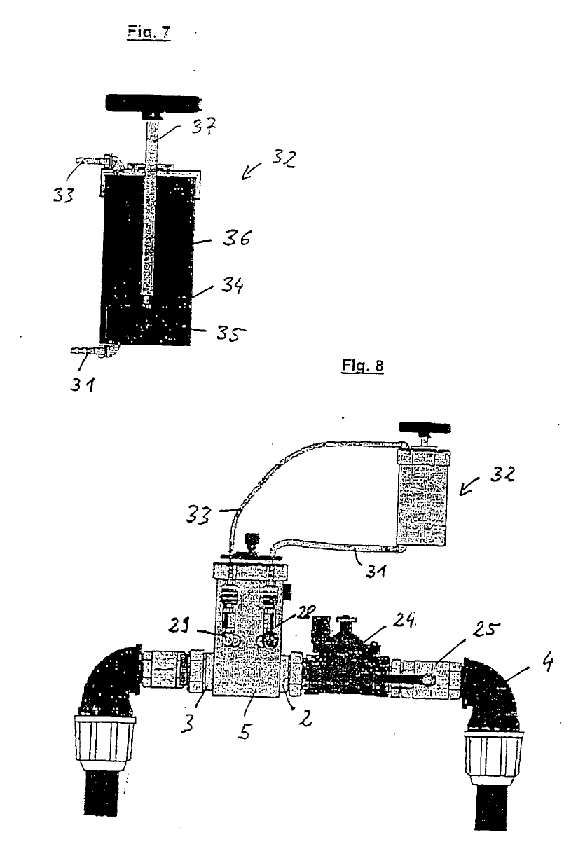

In this manner, in the position of the metering valve shown in FIG. 6, water is pressed into first chamber 35 of container 32 by way of line 31. Piston 34 is thereby gradually displaced upward in FIG. 7, thereby guiding the wetting agent or the like that is capable of flow, which is accommodated in second chamber 36 of container 32, into mixing chamber 16 by way of feed line 33. There, the wetting agent mixes with the water that flows through mixing chamber 16, and gets back into flow channel 5 in second opening 12 in wall 10.

To fill container 33, piston 34 is pressed down in FIG. 7, by way of piston rod 37, so that water accommodated in first chamber 35 flows back by way of line 31. Second chamber 36 is then ready to accommodate a wetting agent or the like that is capable of flow, once again. If a hose that opens into a supply container for wetting agent capable of flow, is connected to second chamber 36, the wetting agent capable of flow can also be drawn directly into second chamber 36 instead of feed line 33, while piston 34 is being pressed down.

Accordingly, while only a few embodiments of the present invention have been shown and described, it is obvious that many changes and modifications may be made thereunto without departing from the spirit and scope of the invention.

### REFERENCE SYMBOL LIST

| | | | |
|---|---|---|---|
| 1 | metering unit | 20 | second closure disk |
| 2 | inlet connector | 21 | stop |
| 3 | outlet connector | 22 | scaling |
| 4 | water line | 23 | display element |
| 5 | flow channel | 24 | solenoid |
| 6 | metering valve | 25 | shut-off slide |
| 7 | first closure disk | 26 | drain valve |
| 8 | drive rod | 27 | ventilation valve |
| 9 | handle | 28 | first branching connection piece |
| 10 | wall | 29 | second branching connection piece |
| 11 | first opening of wall 10 | 30 | shut-off cock |
| 12 | second opening of wall 10 | 31 | line |
| 13 | housing | 32 | container |
| 14 | lid | 33 | feed line |
| 15 | riser pipe | 34 | piston |
| 16 | mixing chamber | 35 | first chamber of the container |
| 17 | ring-shaped wetting agent | 36 | second chamber of the container |
| | tablet | 37 | piston rod |
| 18 | grate | | |
| 19 | opening of the closure disk | | |

What is claimed is:

1. A metering unit for soil and plant improvement agents to increase the water absorption capacity of the soil, comprising:
a first inlet connector that can be connected with a watering line;
a second outlet connector that can be connected with a watering line;
a flow channel that runs between the inlet connector and the outlet connector;
a bypass channel that branches off from the flow channel in a flow direction, leads into a mixing chamber for admixing a soil or plant improvement agent, and opens into the flow channel again from the mixing chamber; and
a metering valve disposed in the flow channel, said metering valve regulating both flow-through amount through the flow channel and flow-through amount through the bypass channel at the same time.

2. A metering unit according to claim 1, wherein the metering valve has a first closure disk, which is adapted to an inside contour of the flow channel in such a manner that the first closure disk can be moved from a closed position in which it at least essentially blocks flow through the flow channel, into an open position in which it at least does not significantly hinder a flow through the flow channel, or vice versa, by rotating said closure disk by 90°.

3. A metering unit according to claim 1, wherein the flow channel is separated from the mixing chamber by a wall having two openings which form two ends of the bypass channel, and wherein the metering valve has a second closure disk, by means of which at least one of the two openings can be opened and closed.

4. A metering unit according to claim 3, wherein the first and second closure disk are coupled with one another so that the second closure disk, in the open position of the first closure disk, at least essentially blocks a flow through the bypass channel, and, in the closed position of the first closure disk, at least does not significantly hinder a flow through the bypass channel.

5. A metering unit according to claim 1, wherein the mixing chamber is formed by a housing in which a centrally disposed riser pipe is provided, said pipe adapted to be connected with the flow channel, and which defines a ring-shaped region of the mixing chamber together with the housing.

6. A metering unit according to claim 5, wherein an activation element is assigned to the metering valve, which element has a drive rod that extends through the riser pipe.

7. A metering unit according to claim 1, wherein for manual activation, the metering valve is connected with a handle, to which a display device or a scaling is assigned.

8. A metering unit according to claim 1, wherein for motor activation, the metering valve is connected with a motor or a setting element, to which a display device or a scaling is assigned.

9. A metering unit according to claim 1, further comprising a grate disposed in the mixing chamber, onto which ring-shaped tablets of a soil or plant improvement agent are set so that a fluid that flows through the bypass channel washes around the tablets and slowly dissolves them.

10. A metering unit according to claim 1, wherein a line branches off from the bypass channel, said line being connected with a container for a soil or plant improvement agent that is capable of flow, so that the soil or plant improvement agent capable of flow is introduced into the bypass channel by means of the fluid pressure in the line, by way of a feed line.

11. A metering unit according to claim 10, wherein a piston is displaceably disposed in the container, said piston dividing the container into a first chamber in which the line branching off from the feed channel ends, and a second chamber from which the feed line branches off, wherein the piston has a larger effective piston surface on a side that faces the first chamber than on a side that faces the second chamber.

12. A metering unit according to claim 1, further comprising a drain valve in a vertically lower region of the mixing chamber, or a ventilation valve in a vertically upper region of the mixing chamber.

13. A metering unit according to claim 5, wherein the housing of the mixing chamber is closed off by a lid that can be releasably attached to the housing.

14. A watering system having a water line and at least one sprinkler or the like connected with said water line, a valve connected to said water line, and a metering unit according to claim 1 disposed in the water line behind the valve, in the flow direction.

15. A watering system according to claim 14, wherein the water line has a main water line and several branch lines branching off from the main line, each of which can be separated from the main water line by a shut-off slide, and wherein the metering unit is disposed behind at least one of the shut-off slides, in the flow direction.
